(19) United States
(12) Patent Application Publication
(10) Pub. No.: US 2019/0348219 A1
(43) Pub. Date: Nov. 14, 2019

(54) METHOD FOR PRODUCING RARE EARTH MAGNET

(71) Applicant: TDK Corporation, Chuo-ku, Tokyo (JP)

(72) Inventors: Toshiya HOZUMI, Chuo-ku, Tokyo (JP); Shuji HIGASHI, Chuo-ku, Tokyo (JP); Atsushi TADA, Chuo-ku, Tokyo (JP)

(73) Assignee: TDK Corporation, Chuo-ku, Tokyo (JP)

(21) Appl. No.: 16/347,628

(22) PCT Filed: Nov. 7, 2017
(86) PCT No.: PCT/JP2017/040096

§ 371 Date: May 6, 2019

(30) Foreign Application Priority Data
Nov. 9, 2016 (JP) 2016-218924

(51) Int. Cl. H01F 41/02; B22F 3/00; B22F 1/00; B22F 3/02; H01F 1/057

(52) U.S. Cl. CPC H01F 41/0246; B22F 3/004; H01F 1/057; B22F 3/02; B22F 1/00

(57) ABSTRACT

A method for producing a rare earth magnet includes a molding step of forming a green compact by supplying a metal powder containing a rare earth element into a mold, an orientation step of orienting the metal powder included in the green compact by applying a magnetic field to the green compact held in the mold, a separation step of separating at least a part of the mold from the green compact after the orientation step, a heating step of heating the green compact after the separation step to adjust the temperature of the green compact to 200° C. or higher and 450° C. or lower, and a sintering step of sintering the green compact after the heating step.

### TECHNICAL FIELD

The present invention relates to a method for producing a rare earth magnet.

### BACKGROUND ART

Rare earth magnets are components of motors, actuators, and the like, and used in various fields such as hard disk drives, hybrid vehicles, electric vehicles, magnetic resonance imaging apparatuses (MRI), smartphones, digital cameras, flat-screen TVs, scanners, air conditioners, heat pumps, refrigerators, vacuum cleaners, washing and drying machines, elevators, and wind power generators, for example. The dimensions and shape required for the rare earth magnets vary depending on these various intended uses. Thus, in order to efficiently produce various kinds of rare earth magnets, a molding method is desired which is capable of easily changing the dimensions and shapes of the rare earth magnets.

In the production of a conventional rare earth magnet, a magnetic field is applied to a metal powder while pressurizing a metal powder (for example, an alloy powder) containing a rare earth element at a high pressure (for example, 50 MPa or more and 200 MPa or less). As a result, a green compact is formed from the metal powder oriented along the magnetic field. Such a molding method will be referred to as a “high-pressure magnetic field pressing method” below. According to the high-pressure magnetic field pressing method, metal powder is easily oriented and it is possible to obtain a green compact having a high residual magnetic flux density Br and an excellent shape retaining ability. A sintered body is obtained by sintering the green compact, and the sintered body is processed into a desired shape, thereby providing a completed magnet product.

However, in the high-pressure magnetic field pressing method, it is necessary to exert a high pressure on the metal powder in the magnetic field, thus requiring a large-scale and complicated molding apparatus, and the dimensions and shape of the metallic mold for molding are restricted. Because of this restriction, the shapes of common green compacts obtained by the high-pressure magnetic field pressing method are limited to coarse blocks. Accordingly, in the case of producing various kinds of magnet products by a conventional method, it is necessary to process the sintered bodies in accordance with the dimensions and shapes required for the magnet products after the sintered bodies are obtained by making block-shaped green compacts sintered. In processing the sintered bodies, the sintered bodies are cut or polished, and scraps containing expensive rare earth elements are thus produced. As a result, the yield rates of the magnet products are decreased. In addition, in the high-pressure magnetic field pressing method, the metallic molds or green compacts are likely to be broken due to galling between the metallic molds or galling between the metallic mold and the green compact. For example, cracks are occasionally generated in the green compacts obtained by the high-pressure magnetic field press method.

For the reasons as mentioned above, the method for production with the use of the conventional high-pressure magnetic field pressing method is not suitable for the production of various kinds or small amounts of magnet products. As a molding method in place of the high pressure magnetic field pressing method, Patent Document 1 below discloses a method of molding an alloy powder at low pressure (0.98 MPa or more and 2.0 MPa or less). This method for manufacturing a rare earth magnet includes a step (filling step) of preparing a green compact by filling a mold with an alloy powder and then pressurizing the alloy powder at a low pressure, a step (orientation step) of orienting the alloy powder in the green compact by applying a magnetic field to the green compact in the mold, and a step (sintering step) of sintering the green compact removed from the mold. In the production method described in Patent Literature 1 below, the filling step and the orientation step are performed in different places.

### CITATION LIST

### Patent Literature

Patent Literature 1: International Publication No. 2016/047593

### SUMMARY OF INVENTION

### Technical Problem

In the case of molding a metal powder at low pressure as in the molding method described in Patent Document 1, durability against high pressures is not required for the metallic mold, and a large-scale and complicated molding apparatus is also unnecessary. Accordingly, in the case of molding a metal powder at a low pressure, the material, dimensions, and shape of the metallic mold are not restricted and it is possible to produce various kinds of rare earth magnets in a relatively easy way with the use of molds having various dimensions and shapes. In addition, the high-pressure magnetic field pressing method requires a long period of time for molding and orienting the metal powder, but molding the metal powder at a low pressure greatly shortens the time required for molding and orientation, thereby improving the productivity of the rare earth magnet.

However, in the molding method described in Patent Document 1 mentioned above, the metal powder is molded at a low pressure, thus it is hard to harden the alloy powder by pressurizing, and the obtained green compact is likely to collapse. Accordingly, the green compact is likely to be broken during removing the green compact from the mold and transferring the green compact to equipment for a subsequent step (for example, sintering step).

The present invention has been made in view of the foregoing problem of the prior art, and an object of the inventions is to provide a method for producing a rare earth magnet, which suppresses cracks in a green compact during the formation of the green compact from a metal powder containing a rare earth element, and improves the shape retaining ability of the green compact.

### Solution to Problem

A method for producing a rare earth magnet according to an aspect of the present invention includes a molding step of forming a green compact by supplying a metal powder containing a rare earth element into a mold, an orientation step of orienting the metal powder included in the green compact by applying a magnetic field to the green compact held in the mold, a separation step of separating at least a part of the mold from the green compact after the orientation step, a heating step of heating the green compact after the separation step to adjust the temperature of the green compact to 200° C. or higher and 450° C. or lower, and a sintering step of sintering the green compact after the heating step.

In the heating step, the green compact may be heated by irradiating the green compact with infrared rays.

In the sintering step, a plurality of green compacts may be placed on a tray for sintering, and the plurality of green compacts placed on the tray for sintering may be heated all at once.

Organic substances may be added to the metal powder supplied into the mold.

The pressure exerted on the metal powder by the mold may be adjusted to 0.049 MPa or more and 20 MPa or less.

In the heating step, the green compact may be heated in an atmosphere including an inert gas or in a vacuum.

In the heating step, the green compact may be heated in an atmosphere including a hydrogen gas.

In the heating step, the green compact may be heated in an atmosphere including a hydrogen gas and an inert gas.

The partial pressure of the hydrogen gas in the atmosphere may be 0 Pa or more and 10 kPa or less.

### Advantageous Effects of Invention

The present invention provides a method for producing a rare earth magnet, which suppresses cracks in a green compact during the formation of the green compact from a metal powder containing a rare earth element, and improves the shape retaining ability of the green compact.

### DESCRIPTION OF EMBODIMENTS

A preferred embodiment of the present invention will be described in detail below. However, the present invention is not limited to the following embodiment.

The rare earth magnet means a sintered magnet in the present embodiment. In the method for the rare earth magnet, an alloy is first cast. The casting method may be, for example, a strip casting method. The alloy may have a flake or ingot form. The alloy contains a rare earth element R. The rare earth element R may be at least one element selected from the group consisting of La, Ce, Pr, Nd, Pm, Sm, Eu, Gd, Tb, Dy, Ho, Er, Tm, Yb, and Lu. The raw material alloy may contain at least one element selected from the group consisting of B, Fe, Co, Cu, Ni, Mn, Al, Nb, Zr, Ti, W, Mo, V, Ga, Zn, Si, and Bi in addition to the rare earth element R. The chemical composition of the alloy may be adjusted depending on the chemical compositions of the main phase and grain boundary phase of the rare earth magnet desired to be finally obtained. In other words, raw materials for the alloy may be prepared by weighing and blending respective starting materials containing the above-mentioned elements depending on the composition of the target rare earth magnet. The rare earth magnet may be, for example, a neodymium magnet, a samarium cobalt magnet, a samarium-iron-nitrogen magnet, or a praseodymium magnet. The main phase of the rare earth magnet may be, for example, Nd₂Fe₁₄B, SmCo₅, Sm₂Co₁₇, Sm₂Fe₁₇N₃, Sm₁Fe₇Nₓ, or PrCo₅. The grain boundary phase may be, for example, a phase (R-rich phase) in which the content of the rare earth element R is higher as compared with the main phase. The grain boundary phase may include a B-rich phase, an oxide phase, or a carbide phase.

A coarse alloy powder is obtained by pulverizing the above-mentioned alloy coarsely. In the coarse pulverizing, for example, the alloy may be pulverized by hydrogen storage in the grain boundary (R-rich phase) of the alloy. In the coarse pulverizing for the alloy, a mechanical pulverizing method may be used, such as a disk mill, a jaw crusher, a Braun mill, or a stamp mill. The particle diameter of the coarse powder obtained by the coarse pulverizing may be, for example, 10 μm or more and 100 μm or less.

A fine powder of the alloy is obtained by pulverizing the coarse powder finely. In fine pulverizing, the alloy powder may be pulverized by a jet mill, a ball mill, a vibration mill, a wet attritor, or the like. The particle diameter of the fine powder obtained by the fine pulverizing may be, for example, 0.5 μm or more and 5 μm or less. Hereinafter, the coarse powder or the fine powder may be referred to as an alloy powder or a metal powder in some cases.

Organic substances may be added to the alloy powder obtained by the coarse pulverizing. Organic substances may be added to the fine powder obtained by the fine pulverizing. In other words, organic substances may be mixed with the metal powder either before or after the fine pulverizing. The organic substances function, for example, as a lubricant. The addition of the lubricant to the metal powder suppresses aggregation of the metal powder. In addition, the addition of the lubricant to the metal powder easily reduces the friction between the mold and the metal powder in a subsequent step. As a result, the metal powder is easily oriented in an orientation step, and damages are easily suppressed at the surface of a green compact obtained from the metal powder or the surface of the mold. The organic substances may be, for example, a fatty acid or a derivative of a fatty acid. The organic substances may be, for example, at least one selected from the group consisting of an oleic acid amide, a zinc stearate, a calcium stearate, a stearic acid amide, a palmitic acid amide, a pentadecyl acid amide, a myristic acid amide, a lauric acid amide, a capric acid amide, a pelargonic acid amide, a caprylic acid amide, an enanthic acid amide, a caproic acid amide, a valeric acid amide, and a butyric acid amide. The lubricant may be a powdery organic substance. The lubricant may be a liquid organic substance. An organic solvent in which a powdery lubricant is dissolved may be added to the alloy powder.

In a molding step, the alloy powder obtained in accordance with the above-mentioned procedure is fed into the mold to form a green compact. The mold includes, for example, a lower mold, a cylindrical side mold disposed on the lower mold, and an upper mold (punch) disposed on the side mold. A space corresponding to the shape and dimensions of the rare earth magnet penetrates through the side mold in the vertical direction. The side mold may be paraphrased as a side wall of the mold. The lower mold may have a plate form. The position of the side mold in the horizontal direction may be fixed by fitting a lower part of the side mold to the stops formed on the surface of the lower mold. In the molding step, the side mold is placed on the lower mold, and the opening (hole) of the side mold on the lower side is covered with the lower mold. With such a configuration, the side mold and the lower mold constitute a cavity (female mold). Subsequently, the alloy powder is introduced into the cavity from the opening (hole) on the upper side of the side mold. As a result, the alloy powder is molded in the cavity so as to correspond to the shape and dimensions of the rare earth magnet. The alloy powder may be adapted to fill the cavity. In other words, the cavity may be filled with the alloy powder. The upper mold may be paraphrased as a core (male mold). The upper mold may have a shape that fits into the cavity. The upper mold may be inserted into the cavity. The green compact (alloy powder) in the cavity may be compressed by the end surface of the upper mold. However, the density of the green compact sufficiently increases only by sintering the alloy powders in a sintering step, thereby providing a rare earth magnet with a desired density, and thus, it is not necessary to compress the alloy powder in the cavity.

The structure of the mold is not limited to the above-mentioned structure. The composition of the mold is not limited. The mold may be composed of, for example, at least one selected from the group consisting of iron, silicon steel, stainless steel, permalloy, aluminum, molybdenum, tungsten, carbonaceous materials, ceramics, and silicone resins. The mold may be composed of an alloy (for example, an aluminum alloy).

In the molding step, the pressure exerted on the alloy powder by the mold may be adjusted to 0.049 MPa or more and 20 MPa or less (0.5 kgf/cm² or more and 200 kgf/cm² or less). The pressure may be, for example, the pressure exerted by the end surface of the upper mold on the alloy powder. As just described, forming a green compact from the alloy powder at a lower pressure than in a conventional high-pressure magnetic field pressing method easily reduces the friction between the mold and the green compact, and easily suppresses breakages of the mold or green compact (for example, cracks in the green compact). If the pressure is excessively high, the mold bends, it is difficult to secure the target capacity of the cavity, and it is difficult to obtain the target density of the green compact. In the conventional high-pressure magnetic field pressing method, it has been necessary to simultaneously mold and orient the alloy powder under high pressure. On the other hand, according to the present embodiment, it is unnecessary to perform the molding and the orientation simultaneously, thus the orientation step can be performed after the molding step. Separating the molding step and the orientation step makes it possible to use smaller and more inexpensive apparatuses (for example, a press molding apparatus and a magnetic field applying apparatus) for each step than conventional apparatuses. The molding step and the orientation step may be performed almost simultaneously.

In the orientation step, a magnetic field is applied to the green compact held in the mold. In other words, a magnetic field is applied to the green compact in the mold to orient the alloy powder constituting the green compact along the magnetic field in the mold. The magnetic field may be a pulsed magnetic field or a static magnetic field. For example, a magnetic field may be applied to the green compact in the mold by disposing the green compact held in the mold together with the mold inside an air-core coil (solenoid coil), and applying an electric current to the air-core coil. A magnetic field may be applied to the green compact in the mold by applying an electric current to a double coil or a Helmholtz coil. The double coil is a magnetic field generation device that has two coils arranged so as to have the same central axis. The use of the double coil or the Helmholtz coil makes it possible to apply a more homogeneous magnetic field to the green compact, as compared with the case of using the air core coil. As a result, the orientation of the alloy powder in the green compact is easily improved, and the magnetic property of the finally obtained rare earth magnet is easily improved. A magnetic field may be applied to the green compact in the mold with the use of a magnetizing yoke. The strength of the magnetic field applied to the green compact in the mold may be, for example, 796 kA/m or more and 5173 kA/m or less (10 kOe or more and 65 kOe or less). After the orientation step, the green compact may be demagnetized. The strength of the magnetic field applied to the green compact in the mold is not necessarily limited to the range mentioned above.

While pressurizing the alloy powder in the mold, the alloy powder may be oriented in a magnetic field. In other words, also in the orientation step, the green compact in the mold may be compressed. The pressure exerted on the green compact by the mold may be adjusted to 0.049 MPa or more and 20 MPa or less for the reason mentioned above.

In the separation step, at least a part of the mold is separated from the green compact. For example, in the separation step, the upper mold and the side mold may be separated and removed from the green compact, thereby placing the green compact on the lower mold. The side mold and upper mold holding the green compact may be separated from the lower mold to place the side mold and upper mold holding the green compact on a tray for the heating step. Then, the side mold and the upper mold may be separated from the green compact to place the green compact on the tray for the heating step. One or both of the upper mold and the side mold may be able to be disassembled and assembled. In the separation step, one or both of the upper mold and the side mold may be removed from the green compact by disassembling one or both of the upper mold and the side mold.

The density of the green compact (the green compact before the heating step) which has undergone the molding step and the orientation step may be adjusted to, for example, 3.0 g/cm³ or more and 4.4 g/cm³ or less, preferably 3.2 g/cm³ or more and 4.2 g/cm³ or less, more preferably 3.4 g/cm³ or more and 4.0 g/cm³ or less.

In the heating step following the separation step, the green compact is heated to adjust the temperature of the green compact to 200° C. or higher to 450° C. or lower. In the heating step, the temperature of the green compact may be adjusted to 200° C. or higher and 400° C. or lower, or 200° C. or higher and 350° C. or lower. In the molding step, the pressure on the alloy powder is lower than that in the conventional high-pressure magnetic field pressing method, thus making it difficult to harden the alloy powder by pressurizing, and making the obtained green compact likely to collapse. However, the shape retaining ability of the green compact is improved by the heating step.

In the heating step, when the temperature of the green compact reaches 200° C. or higher, the green compact begins to be hardened, thereby improving the shape retaining ability of the green compact. In other words, when the temperature of the green compact reaches 200° C. or higher, the mechanical strength of the green compact is improved. Since the shape retaining ability of the green compact is improved, the green compact is unlikely to be broken in transfer of the green compact or handling of the green compact in a subsequent step. For example, the green compact is unlikely to collapse when the green compact is gripped with a carrying chuck or the like, and disposed on a tray for sintering. As a result, defects of the finally obtained rare earth magnet are suppressed.

If the temperature of the green compact exceeds 450° C. in the heating step, cracks in the green compact is likely to be formed in the sintering step performed after the heating step. The cause of the crack formation is not certain. For example, hydrogen remaining in the green compact may blow off as a gas to the outside of the green compact by a rapid increase in green compact temperature in the heating step, thereby cracks in the green compact could be formed. However, according to the present embodiment, the temperature of the green compact is adjusted to 450° C. or lower in the heating step, thus cracks in the green compact are suppressed in the sintering step. As a result, cracks in the finally obtained rare earth magnet are also easily suppressed. In addition, the temperature of the green compact is adjusted to 450° C. or lower in the heating step, thus shortening the time required for increasing the green compact temperature or cooling the green compact, and improving the productivity of the rare earth magnet In addition, the temperature of the green compact in the heating step is 450° C. or lower, which is lower than the general sintering temperature, thus deterioration of mold or a chemical reaction between the green compact and the mold is unlikely to be caused, even if the green compact is heated together with a part of the mold (for example, the lower mold). Accordingly, even a mold composed of a composition which is not necessarily high in heat resistance can be used.

The mechanism that the shape retaining ability of the green compact is improved by adjusting the temperature of the green compact to 200° C. or higher and 450° C. or lower is not clear. For example, there is a possibility that an organic substance (for example, a lubricant) added to the alloy powders will turn into carbon (for example, amorphous carbon) in the heating step, thereby binding the alloy powders (alloy particles) to each other with the carbon interposed therebetween. As a result, the shape retaining ability of the green compact may be improved. If the temperature of the green compact exceeds 450° C. in the heating step, there is a possibility that a carbide of the metal constituting the alloy powder will be formed, or the alloy powders (alloy particles) may be sintered directly to each other. On the other hand, in a case in which the temperature of the green compact is adjusted to 200° C. or higher and 450° C. or lower, a carbide of the metal is not necessarily produced, and the alloy particles are not necessarily sintered directly to each other.

The time for keeping the temperature of the green compact at 200° C. or higher and 450° C. or lower in the heating step is not particularly limited, and may be appropriately adjusted in accordance with the dimensions and shape of the green compact.

In the heating step, the green compact may be heated by irradiating the green compact with infrared rays. Directly heating the green compact by infrared irradiation (that is, radiant heat) shortens the time required for increasing the temperature of the green compact as compared with a case of heating by conduction or convection, thereby improving the production efficiency and the energy efficiency. However, in the heating step, the green compact may be heated by heat conduction or convection inside a heating furnace. The wavelength of the infrared ray may be, for example, 0.75 μm or more and 1000 μm or less, preferably 0.75 μm or more and 30 μm or less. The infrared ray may be at least one selected from the group consisting of near infrared rays, short wavelength infrared rays, medium wavelength infrared rays, long wavelength infrared rays (thermal infrared rays), and far infrared rays. Among the infrared rays mentioned above, the near infrared rays are relatively easily absorbed by metals. Accordingly, in the case of irradiating the green compact with near infrared rays, the temperature of the metal (alloy powder) is easily increased in a short period of time. On the other hand, among the infrared rays mentioned above, the far infrared rays are easily absorbed by organic substances, and easily reflected by metals (alloy powder). Accordingly, in the case of irradiating the green compact with far infrared rays, the above-described organic substance (for example, a lubricant) is easily selectively heated, and the green compact is easily hardened by the above-mentioned mechanism associated with the organic substance. In the case of irradiating the green compact with infrared rays, for example, an infrared heater (ceramic heater or the like) or an infrared lamp may be used.

According to the present embodiment, the heating step is performed after the separation step. In other words, in the heating step, the green compact separated from a part or all of the mold is heated, thus easily suppressing deterioration of the mold due to the heating (for example, deformation, hardening, or abrasion of the mold), and also easily suppressing seizure between the green compact and the mold. In addition, in the heating step, the green compact separated from a part or all of the mold is heated, thus making the mold hard to insulate heat, and then the green compact is easily heated. As a result, the shape retaining ability of the green compact is improved. In the heating step, the green compact separated from a part or all of the mold is heated, thus making the mold less likely to chemically react with the green compact. Thus, heat resistance is not necessarily required for the mold, and the material of the mold is hardly restricted. Accordingly, as a raw material for the mold, it is easy to select a material which is easily processed into desired dimensions and shape and inexpensive. If the green compact and the whole of the mold are heated all at once in the heating step, stress is likely to act on the green compact due to a difference in thermal expansion coefficient between the green compact and the mold, thereby deforming or breaking the green compact. In addition, if the green compact and the whole of the mold are heated all at once in the heating step, whole of the heating objective is large in volume and heat capacity. As a result, the number of green compacts to be heated all at once is limited, thereby increasing the time required for the heating step, resulting in energy waste, and decreasing the productivity of the rare earth magnet.

In the heating step, for example, the green compact placed on the lower mold may be heated. In the heating step, the green compact placed on a tray for the heating step may be heated. In the heating step, in order to suppressing oxidization of the green compact, the green compact may be heated in an atmosphere including an inert gas or in a vacuum. The inert gas may be a rare gas such as argon. In the heating step, the green compact may be heated in an atmosphere composed of only an inert gas. In the heating step, the green compact may be heated in an atmosphere including a hydrogen gas. Heating the green compact in the presence of a hydrogen gas accelerates decomposition of the organic substance in the green compact (for example, cleavage of a carbon-carbon bond in the organic substance), thereby easily producing carbon (for example, amorphous carbon). This carbon binds the metal powders in the green compact to each other, thereby making the green compact hard as a whole. For the foregoing reasons, heating the green compact in an atmosphere including a hydrogen gas shortens the time required for hardening the green compact in the heating step. The mechanism related to heating the green compact in the presence of hydrogen gas is, however, not limited to the mechanism mentioned above. In the heating step, the green compact may be heated in an atmosphere composed of only a hydrogen gas. In the heating step, the green compact may be heated in an atmosphere including a hydrogen gas and an inert gas. In the heating step, the green compact may be heated in an atmosphere composed of only a hydrogen gas and an inert gas. The partial pressure of the hydrogen gas in the atmosphere of the heating step is 0 Pa or more and 10 kPa or less, 0 Pa or more and 8 kPa or less, 0 Pa or more and 5 kPa or less, 0 Pa or more and 1 kPa or less, 0 Pa or more and 100 Pa or less, 20 Pa or more and 8 kPa or less, or 20 Pa or more and 100 Pa or less. In a case in which the partial pressure of the hydrogen gas falls within the foregoing ranges, the time required for hardening the green compact is easily shortened in the heating step. In a case in which the partial pressure of the hydrogen gas is excessively high, the hydrogen gas is easily taken into the green compact in the heating step, and in the subsequent sintering step, the hydrogen gas easily blows out vigorously from the green compact. The hydrogen gas vigorously blowing out from the green compact could crack the green compact. However, even in a case in which the partial pressure of the hydrogen gas in the atmosphere of the heating step falls outside the ranges mentioned above, it is possible to achieve the advantageous effect of the present invention. In a case in which the atmosphere of the heating step is composed of only a hydrogen gas, “the partial pressure of the hydrogen gas in the atmosphere” may be paraphrased as “the total pressure of the atmosphere” or “the pressure of the hydrogen gas”.

In the heating step, the green compact may be cooled to 100° C. or lower after adjusting the temperature of the green compact to 200° C. or higher and 450° C. or lower. When the surface of chuck used for transfer of the green compact after the heating step is made of a resin, the cooling of the green compact suppresses a chemical reaction between the surface of the chuck and the green compact, thereby suppressing deterioration of the chuck and contamination of the surface of the green compact. The cooling method may be natural cooling, for example.

In the sintering step following the heating step, the green compact is heated to be sintered. In other words, in the sintering step, the alloy particles in the green compact are sintered to each other to obtain a sintered body (rare earth magnet).

The density of the green compact to be sintered in the sintering step (the density of the green compact just before the sintering step) may be adjusted to, for example, 3.0 g/cm³ or more and 4.4 g/cm³ or less, preferably 3.2 g/cm³ or more and 4.2 g/cm³ or less, more preferably 3.4 g/cm³ or more and 4.0 g/cm³ or less. As the pressure exerted on the green compact (alloy powder) by the mold is lower in the molding step and the orientation step, the density of the green compact tends to be lower just before the sintering step. In addition, as the pressure exerted on the green compact (alloy powder) by the mold is lower in the molding step and the orientation step, the alloy powder constituting the green compact is more likely to freely rotate, and more likely to be oriented along the magnetic field. As a result, the residual magnetic flux density of the rare earth magnet finally obtained is more likely to be increased. Thus, it can be said that the residual magnetic flux density of the rare earth magnet is more likely to be increase as the density of the green compact just before the sintering step is lower. However, if the pressure exerted on the green compact (alloy powder) by the mold is excessively low in the molding step and the orientation step, the shape retaining ability (mechanical strength) of the green compact is insufficient, and the orientation of the alloy powder located at the surface of the green compact is disturbed by the friction between the green compact and the mold associated with the separation step. As a result, the residual magnetic flux density of the finally obtained rare earth magnet is decreased. Accordingly, if the density of the green compact just before the sintering step is excessively low, it can be said that the residual magnetic flux density of the rare earth magnet is low.

On the other hand, as the pressure exerted on the green compact (alloy powder) is higher during the period from the molding step to the sintering step, the density of the green compact just before the sintering step is higher, and the shape retaining ability (mechanical strength) of the green compact is higher. As a result, cracks in the finally obtained rare earth magnet are more likely suppressed. Accordingly, it can be said that cracks in the rare earth magnet are more likely to be suppressed as the density of the green compact immediately before the sintering step is higher. However, if the pressure exerted on the green compact (alloy powder) by the mold is excessively high in the molding step and the orientation step, cracks in the green compact is likely to be formed due to springback, and cracks remain in the rare earth magnet obtained from the green compact. It is to be noted that the springback is a phenomenon in which the green compact expands when the pressure is released after molding the alloy powder under pressure. As described above, the density of the green compact just before the sintering step correlates with the residual magnetic flux density and the crack in the rare earth magnet. The density of the green compact just before the sintering step is adjusted to fall within the ranges mentioned above, thereby easily increasing the residual magnetic flux density of the rare earth magnet, and cracks in the rare earth magnet is easily suppressed.

In the sintering step, the green compact placed on the lower mold may be transferred onto a tray for sintering. In the sintering step, the green compact placed for the heating step may be transferred onto a tray for sintering. Since the shape retaining ability of the green compact is improved in the heating step, breakage of the green compact is suppressed when the green compact is gripped with a carrying chuck, and arranged on the tray for sintering.

In the sintering step, a plurality of green compacts may be placed on a tray for sintering, and the plurality of green compacts placed on the tray for sintering may be heated all at once. The productivity of the rare earth magnet is improved by arranging a large number of green compacts on the tray for sintering at a narrow interval, and heating the large number of green compacts all at once.

The composition of the tray for sintering may be any composition as long as the composition is unlikely to react with the green compact during the sintering and unlikely to produce a substance which contaminates the green compact. For example, the tray for sintering may be made of molybdenum or a molybdenum alloy.

The sintering temperature may be, for example, 900° C. or higher and 1200° C. or lower. The sintering time may be, for example, 0.1 hour or longer and 100 hours or shorter. The sintering step may be repeated. In the sintering step, the green compact may be heated in an inert gas or a vacuum. The inert gas may be a rare gas such as argon.

The sintered body may be subjected to an aging treatment. In the aging treatment, the sintered body may be subjected to a heat treatment at, for example, 450° C. or higher and 950° C. or lower. In the aging treatment, the sintered body may be subjected to a heat treatment for, for example, 0.1 hour or longer and 100 hours or shorter. The aging treatment may be carried out in an inert gas or a vacuum. The aging treatment may be composed of multi-step heat treatments at different temperatures.

The sintered body may be cut or polished. A protective layer may be formed on the surface of the sintered body. The protective layer may be, for example, a resin layer or an inorganic layer (for example, a metal layer or an oxide layer). The method for forming the protective layer may be, for example, a plating method, a coating method, a vapor deposition polymerization method, a gas-phase method, or a chemical conversion treatment method.

The dimensions and shape of the rare earth magnet varies depending on the intended use of the rare earth magnet, and are not particularly limited. The shape of the rare earth magnet may be, for example, a rectangular parallelepiped shape, a cubic shape, a polygonal prism shape, a segment shape, a fan shape, a rectangular shape, a plate shape, a spherical shape, a disk shape, a cylindrical shape, a ring shape, or a capsule shape. The cross section of the rare earth magnet may have, for example, a polygonal shape, a circular chord shape, an arcuate shape, or a circular shape. The dimensions and shape of the mold or cavity corresponds to the dimensions and shape of the rare earth magnet, which are not limited.

### EXAMPLES

Hereinafter, the present invention will be described in more detail with reference to examples, but the present invention is not to be limited to these examples.

### Example 1

A flaky alloy containing Nd₂Fe₁₄B as its main component was prepared by a strip casting method. The alloy was subjected to coarse pulverizing by a hydrogen storage method to obtain a coarse powder. An oleic acid amide (lubricant) was added to the coarse powder. Subsequently, the coarse powder was pulverized in an inert gas with a jet mill to obtain a fine powder (a metal powder containing a rare earth element).

In a molding step, the fine powder with the oleic acid amide added was supplied into a mold to form a green compact. Here are details of the molding step.

The mold was provided with a rectangular lower mold, a rectangular parallelepiped side mold disposed on the lower mold, and an upper mold disposed on the side mold. A rectangular parallelepiped space penetrated the center part of the side mold in the vertical direction. In other words, the side mold was cylindrical. The upper mold had a shape fitted into the side mold. In the molding step, the side mold was placed on the lower mold, and the opening of the side mold on the lower side was covered with the lower mold. Subsequently, the side mold was filled with the above fine powder from the opening of the side mold on the upper side. The upper mold was inserted into the side mold to compress the fine powder in the side mold by the end surface of the upper mold.

In an orientation step, the green compact held in the mold was disposed in an air-core coil, and a pulsed magnetic field was applied to the green compact in the mold.

In a separation step following the orientation step, the upper mold and the side mold were separated from the green compact to place the green compact on the lower mold.

In a heating step, the green compact placed on the lower mold was irradiated with infrared rays to heat the green compact. Then, after the green compact was heated up to 200° C., the temperature of the green compact was kept at 200° C. for 3 minutes. The rate of increasing the temperature of the green compact was about 10° C./second. In the foregoing heating step, the green compact was heated in an argon gas. In other words, in the heating step, the green compact in the argon was irradiated with infrared rays.

After the heating step, the green compact was transferred from the lower mold to a tray for sintering by using a carrying chuck. When the green compact was gripped with the carrying chuck, the molded was not broken. In other words, it was confirmed that the green compact after the heating step of Example 1 has shape retaining ability (hardness) to the extent that the green compact was not broken by being gripped.

In a sintering step, the green compact placed on the tray for sintering was heated at 1070° C. for 4 hours. The rare earth magnet (sintered body) obtained in the sintering step was visually observed. No crack was generated in the rare earth magnet of Example 1.

### Example 2

In a heating step of Example 2, the green compact placed on the lower mold was irradiated with infrared rays to heat the green compact. Then, after the green compact was heated up to 300° C., the temperature of the green compact was kept at 300° C. for 3 minutes. The rate of increasing the temperature of the green compact in the heating step of Example 2 was the same as in Example 1. Also in the heating step of Example 2, the green compact was heated in an argon gas. In other words, in the heating step, the green compact in the argon was irradiated with infrared rays.

After the heating step, when the green compact of Example 2 was gripped with a carrying chuck, the green compact was not broken.

In the same way as in Example 1 except for the heating step mentioned above, a rare earth magnet of Example 2 was produced. The rare earth magnet of Example 2 was visually observed. No crack was generated in the rare earth magnet of Example 2.

### Example 3

In a heating step of Example 3, the green compact placed on the lower mold was irradiated with infrared rays to heat the green compact. Then, after the green compact was heated up to 350° C., the temperature of the green compact was kept at 350° C. for 3 minutes. The rate of increasing the temperature of the green compact in the heating step of Example 3 was the same as in Example 1. Also in the heating step of Example 3, the green compact was heated in an argon gas. In other words, in the heating step, the green compact in the argon was irradiated with infrared rays.

After the heating step, when the green compact of Example 3 was gripped with the carrying chuck, the green compact was not broken.

In the same way as in Example 1 except for the heating step mentioned above, a rare earth magnet of Example 3 was produced. The rare earth magnet of Example 3 was visually observed. No crack was generated in the rare earth magnet of Example 3.

### Example 4

In a heating step of Example 4, the green compact placed on the lower mold was irradiated with infrared rays to heat the green compact. Then, after the green compact was heated up to 450° C., the temperature of the green compact was kept at 450° C. for 3 minutes. The rate of increasing the temperature of the green compact in the heating step of Example 4 was the same as in Example 1. Also in the heating step of Example 4, the green compact was heated in an argon gas. In other words, in the heating step, the green compact in the argon was irradiated with infrared rays.

After the heating step, when the green compact of Example 4 was gripped with a carrying chuck, the green compact was not broken.

In the same way as in Example 1 except for the heating step mentioned above, a rare earth magnet of Example 4 was produced. The rare earth magnet of Example 4 was visually observed. No crack was generated in the rare earth magnet of Example 4.

### Comparative Example 1

According to Comparative Example 1, a green compact was prepared in the same way as in Example 1. However, according to Comparative Example 1, the heating step was not carried out. As a result of grasping the green compact of Comparative Example 1, subjected to no heating step, with a carrying chuck, the green compact collapsed into pieces. Thus, it was impossible to carry out the sintering step of Comparative Example 1.

### Comparative Example 2

In a heating step of Comparative Example 2, a green compact placed on the lower mold was irradiated with infrared rays to heat the green compact. Then, after the green compact was heated up to 500° C., the temperature of the green compact was kept at 500° C. for 3 minutes. The rate of increasing the temperature of the green compact in the heating step of Comparative Example 2 was the same as in Example 1. Also in the heating step of Comparative Example 2, the green compact was heated in an argon gas. In other words, in the heating step, the green compact in the argon was irradiated with infrared rays.

After the heating step, when the green compact of Comparative Example 2 was gripped with a carrying chuck, the green compact was not broken.

In the same way as in Example 1 except for the heating step mentioned above, a rare earth magnet of Comparative Example 2 was produced. The rare earth magnet of Comparative Example 2 was visually observed. Cracks were formed in the rare earth magnet of Comparative Example 2.

### Example 5

In a heating step of Example 5, the green compact placed on the lower mold was irradiated with infrared rays to heat the green compact. Then, after the green compact was heated up to 200° C., the temperature of the green compact was kept at 200° C. for 2 minutes. The rate of increasing the temperature of the green compact in the heating step of Example 5 was the same as in Example 1. In the heating step of Example 5, the green compact was heated in an atmosphere composed of an argon gas and a hydrogen gas. In other words, in the heating step, the green compact in the atmosphere composed of the argon gas and the hydrogen gas was irradiated with infrared rays. The partial pressure of the hydrogen gas in the atmosphere in the heating step was 100 Pa.

After the heating step, when the green compact of Example 5 was gripped with a carrying chuck, the green compact was not broken.

In the same way as in Example 1 except for the heating step mentioned above, a rare earth magnet of Example 5 was produced. The rare earth magnet of Example 5 was visually observed. No crack was generated in the rare earth magnet of Example 5.

The temperature (200° C.) of the green compact in the heating step of Example 5 was the same as in Example 1, but the retention time (2 minutes) of the temperature of the green compact of Example 5 was shorter than the retention time (3 minutes) in the case of Example 1. Nevertheless, also in the case of Example 5, the green compact after the heating step was not broken, and no crack was generated in the rare earth magnet. In other words, Example 5 shows that the heating time (the time required for hardening the green compact) is shortened by heating the green compact in an atmosphere containing a hydrogen gas.

### Example 6

In a heating step of Example 6, the green compact placed on the lower mold was irradiated with infrared rays to heat the green compact. Then, after the green compact was heated up to 300° C., the temperature of the green compact was kept at 300° C. for 1 minutes. The rate of increasing the temperature of the green compact in the heating step of Example 6 was the same as in Example 1. In the heating step of Example 6, the green compact was heated in an atmosphere composed of an argon gas and a hydrogen gas. In other words, in the heating step, the green compact in the atmosphere composed of the argon gas and the hydrogen gas was irradiated with infrared rays. The partial pressure of the hydrogen gas in the atmosphere in the heating step was 100 Pa.

After the heating step, when the green compact of Example 6 was gripped with a carrying chuck, the green compact was not broken.

In the same way as in Example 1 except for the heating step mentioned above, a rare earth magnet of Example 6 was produced. The rare earth magnet of Example 6 was visually observed. No crack was generated in the rare earth magnet of Example 6.

The temperature (300° C.) of the green compact in the heating step of Example 6 was the same as in Example 2, but the retention time (1 minute) of the temperature of the green compact of Example 6 was shorter than the retention time (3 minutes) in the case of Example 2. Nevertheless, also in the case of Example 6, the green compact after the heating step was not broken, and no crack was generated in the rare earth magnet. In other words, Example 6 shows that the heating time (the time required for hardening the green compact) is shortened by heating the green compact in an atmosphere containing a hydrogen gas.

### Example 7

In a heating step of Example 7, the green compact placed on the lower mold was irradiated with infrared rays to heat the green compact. Then, after the green compact was heated up to 300° C., the temperature of the green compact was kept at 300° C. for 2 minutes. The rate of increasing the temperature of the green compact in the heating step of Example 7 was the same as in Example 1. In the heating step of Example 7, the green compact was heated in an atmosphere composed of an argon gas and a hydrogen gas. In other words, in the heating step, the green compact in the atmosphere composed of the argon gas and the hydrogen gas was irradiated with infrared rays. The partial pressure of the hydrogen gas in the atmosphere in the heating step was 20 Pa.

After the heating step, when the green compact of Example 7 was gripped with a carrying chuck, the green compact was not broken.

In the same way as in Example 1 except for the heating step mentioned above, a rare earth magnet of Example 7 was produced. The rare earth magnet of Example 7 was visually observed. No crack was generated in the rare earth magnet of Example 7.

The temperature (300° C.) of the green compact in the heating step of Example 7 was the same as in Example 2, but the retention time (2 minutes) of the temperature of the green compact of Example 7 was shorter than the retention time (3 minutes) in the case of Example 2. Nevertheless, also in the case of Example 7, the green compact after the heating step was not broken, and no crack was generated in the rare earth magnet. In other words, Example 7 shows that the heating time (the time required for hardening the green compact) is shortened by heating the green compact in an atmosphere containing a hydrogen gas.

### Example 8

In a heating step of Example 8, the green compact placed on the lower mold was irradiated with infrared rays to heat the green compact. Then, after the green compact was heated up to 300° C., the temperature of the green compact was kept at 300° C. for 3 minutes. The rate of increasing the temperature of the green compact in the heating step of Example 7 was the same as in Example 1. In the heating step of Example 8, the green compact was heated in a vacuum substantially in the absence of both argon gas and hydrogen gas. In other words, in the heating step, the green compact in the vacuum was irradiated with infrared rays.

After the heating step, when the green compact of Example 8 was gripped with a carrying chuck, the green compact was not broken.

In the same way as in Example 1 except for the heating step mentioned above, a rare earth magnet of Example 8 was produced. The rare earth magnet of Example 8 was visually observed. No crack was generated in the rare earth magnet of Example 8.

### Example 9

In a heating step of Example 9, the green compact placed on the lower mold was irradiated with infrared rays to heat the green compact. Then, after the green compact was heated up to 300° C., the temperature of the green compact was kept at 300° C. for 1 minutes. The rate of increasing the temperature of the green compact in the heating step of Example 9 was the same as in Example 1. In the heating step of Example 9, the green compact was heated in an atmosphere composed of only a hydrogen gas. In other words, in the heating step, the green compact in the hydrogen gas was irradiated with infrared rays. The total pressure of the atmosphere (that is, the atmospheric pressure of the hydrogen gas) in the heating step was 100 Pa.

After the heating step, when the green compact of Example 9 was gripped with a carrying chuck, the green compact was not broken.

In the same way as in Example 1 except for the heating step mentioned above, a rare earth magnet of Example 9 was produced. The rare earth magnet of Example 9 was visually observed. No crack was generated in the rare earth magnet of Example 9.

The temperature (300° C.) of the green compact in the heating step of Example 9 was the same as in Example 2, but the retention time (1 minute) of the temperature of the green compact of Example 9 was shorter than the retention time (3 minutes) in the case of Example 2. Nevertheless, also in the case of Example 9, the green compact after the heating step was not broken, and no crack was generated in the rare earth magnet. In other words, Example 9 shows that the heating time (the time required for hardening the green compact) is shortened by heating the green compact in a hydrogen gas.

### Example 10

In a heating step of Example 10, the green compact placed on the lower mold was irradiated with infrared rays to heat the green compact. Then, after the green compact was heated up to 200° C., the temperature of the green compact was kept at 200° C. for 1 minute. The rate of increasing the temperature of the green compact in the heating step of Example 10 was the same as in Example 1. In the heating step of Example 10, the green compact was heated in an atmosphere composed of an argon gas and a hydrogen gas. In other words, in the heating step, the green compact in the atmosphere composed of the argon gas and the hydrogen gas was irradiated with infrared rays. The partial pressure of the hydrogen gas in the atmosphere in the heating step was 8000 Pa.

After the heating step, when the green compact of Example 10 was gripped with a carrying chuck, the green compact was not broken.

In the same way as in Example 1 except for the heating step mentioned above, a rare earth magnet of Example 10 was produced. The rare earth magnet of Example 10 was visually observed. No crack was generated in the rare earth magnet of Example 10

The temperature (200° C.) of the green compact in the heating step of Example 10 was the same as in Example 1, but the retention time (1 minute) of the temperature of the green compact of Example 10 was shorter than the retention time (3 minutes) in the case of Example 1. Nevertheless, also in the case of Example 10, the green compact after the heating step was not broken, and no crack was generated in the rare earth magnet. In other words, Example 10 shows that the heating time (the time required for hardening the green compact) is shortened by heating the green compact in an atmosphere containing a hydrogen gas.

### INDUSTRIAL APPLICABILITY

Owing to the method for producing a rare earth magnet according to the present invention, it is possible to produce various types of rare earth magnets depending on various intended uses such as hard disk drives, hybrid vehicles, or electric vehicles, and it is possible to reduce the production cost even when the production volume is small.

1. A method for producing a rare earth magnet, the method comprising:
a molding step of forming a green compact by supplying a metal powder containing a rare earth element into a mold;
an orientation step of orienting the metal powder included in the green compact by applying a magnetic field to the green compact held in the mold;
a separation step of separating at least a part of the mold from the green compact after the orientation step;
a heating step of heating the green compact after the separation step to adjust a temperature of the green compact to 200° C. or higher and 450° C. or lower; and
a sintering step of sintering the green compact after the heating step.

2. The method for producing a rare earth magnet according to claim 1,
wherein in the heating step, the green compact is heated by irradiating the green compact with an infrared ray.

3. The method for producing a rare earth magnet according to claim 1,
wherein in the sintering step, a plurality of the green compacts is placed on a tray for sintering, and the plurality of green compacts placed on the tray for sintering is heated all at once.

4. The method for producing a rare earth magnet according to claim 1,
wherein an organic substance is added to the metal powder supplied into the mold.

5. The method for producing a rare earth magnet according to claim 1,
wherein a pressure exerted on the metal powder by the mold is adjusted to 0.049 MPa or more and 20 MPa or less.

6. The method for producing a rare earth magnet according to claim 1,
wherein in the heating step, the green compact is heated in an atmosphere including an inert gas or in a vacuum.

7. The method for producing a rare earth magnet according to claim 1,
wherein in the heating step, the green compact is heated in an atmosphere including a hydrogen gas.

8. The method for producing a rare earth magnet according to claim 1,
wherein in the heating step, the green compact is heated in an atmosphere including a hydrogen gas and an inert gas.

9. The method for producing a rare earth magnet according to claim 6,
wherein a partial pressure of hydrogen gas in the atmosphere is 0 Pa or more and 10 kPa or less.

10. The method for producing a rare earth magnet according to claim 7,
wherein a partial pressure of hydrogen gas in the atmosphere is 0 Pa or more and 10 kPa or less.

11. The method for producing a rare earth magnet according to claim 8,
wherein a partial pressure of hydrogen gas in the atmosphere is 0 Pa or more and 10 kPa or less.
